(19) United States
(12) Patent Application Publication
(10) Pub. No.: US 2011/0309539 A1
(43) Pub. Date: Dec. 22, 2011

(54) METHOD FOR PRODUCING POLYMER MIXTURES

(75) Inventors: Tobias Heinz Steinke, Speyer (DE); Hans-Helmut Görtz, Freinsheim (DE); Jürgen Ahlers, Gross-Rohrheim (DE); Freddy Gruber, Offenbach (DE); Gabriel Skupin, Speyer (DE)

(73) Assignee: BASF SE, Ludwigshafen (DE)

(21) Appl. No.: 13/254,086

(22) PCT Filed: Mar. 1, 2010
(86) PCT No.: PCT/EP2010/052528

§ 371 Date: Sep. 7, 2011

(30) Foreign Application Priority Data
Mar. 3, 2009 (EP) 09154201.9

(51) Int. Cl. B29B 9/10

(52) U.S. Cl. 264/5

(57) ABSTRACT

The present invention relates to a process for the production of polymer mixtures of i) polypropylene carbonate and ii) at least one further polymer, including the following steps:
(a) reaction of propylene carbonate with carbon dioxide in the presence of a zinc catalyst, cobalt catalyst, or lanthanoid catalyst—in excess propylene carbonate or in an aprotic non-water-miscible solvent,
(b) addition of an aqueous acidic solution to the reaction mixture after termination of the reaction,
(c) removal of the aqueous phase,
(d) optionally washing of the remaining organic phase with water,
(e) addition of polymer component ii),
(f) degassing and drying of the resultant polymer mixture and optionally removal of the aprotic, non-water-miscible solvent, and
(g) pelletization of the polymer melt.

The present invention relates to a process for the production of polymer mixtures of i) polypropylene carbonate and ii) at least one further polymer, including the following steps:
(a) reaction of propylene carbonate with carbon dioxide in the presence of a zinc catalyst, cobalt catalyst, or lanthanoid catalyst—in excess propylene carbonate or in an aprotic non-water-miscible solvent,
(b) addition of an aqueous acidic solution to the reaction mixture after termination of the reaction,
(c) removal of the aqueous phase,
(d) optionally washing of the remaining organic phase with water,
(e) addition of polymer component ii),
(f) degassing and drying of the resultant polymer mixture and optionally removal of the aprotic, non-water-miscible solvent, and
(g) pelletization of the polymer melt.

The invention further relates to a process for the production of polymer mixtures of i) polypropylene carbonate and ii) at least one further polymer, including the following steps:
(a) reaction of propylene carbonate with carbon dioxide in the presence of a zinc catalyst, cobalt catalyst, or lanthanoid catalyst—in excess propylene carbonate or in an aprotic non-water-miscible solvent,
(b) addition of an aqueous acidic solution to the reaction mixture after termination of the reaction,
(c) removal of the aqueous phase,
(d) optionally washing of the remaining organic phase with water,
(e) degassing and drying of the resultant polymer mixture and optionally removal of the aprotic, non-water-miscible solvent,
(f) addition of polymer component ii), and
(g) pelletization of polymer melt.

Pellets or powders of polypropylene carbonate have a tendency toward caking as a consequence of the low glass transition temperature, which is generally below 40° C. This makes the transport, storage, and handling of the material considerably more difficult. By way of example, temperatures of up to 70° C. can be reached in closed spaces, during transport in containers. Polypropylene carbonate consequently cakes and cannot be further processed until it has been subjected to treatment. If plasticizers are present, an example being the cyclic propylene carbonate which arises as byproduct during the production process, the glass transition temperature can be lower than 30° C. The glass transition temperature is also markedly lower if the polypropylene carbonate comprises substoichiometric amounts of carbon dioxide. These types of polypropylene carbonate have a particularly marked tendency toward caking.

Most industrial applications use polypropylene carbonate in a mixture with other polymers. These are single-phase or multiphase mixtures, as a function of the nature and amount of the mixing component. If the mixing components have a relatively high glass transition temperature or—in the case of crystalline or semicrystalline polymers—melting point, the glass transition temperature or softening point of the mixture is then sometimes markedly higher than that of the polypropylene carbonate itself. The processes described in the literature for the production of polypropylene carbonate mixtures use mixing of the pellets of the individual components, and then melting of the pellet mixture in an extruder, and discharge followed by pelletization (WO 2007/125039, JP2007 161837).

It is an object of the present invention to provide a process which can produce a polypropylene carbonate mixture and which can operate without the complicated isolation and storage of propylene carbonate, with its tendency toward caking.

The one-pot process mentioned in the introduction has accordingly been discovered, and adds polymer component(s) ii) in the step (e) prior to the degassing and drying of the crude polycarbonate fraction and optional removal of the aprotic, non-water-miscible solvent, or in step (f) prior to the pelletization of the polycarbonate melt.

The expression polypropylene carbonates means the polymers produced via copolymerization of propylene oxide and carbon dioxide (see WO 2006/061237).

The polypropylene carbonate chain can comprise ether groups and carbonate groups. The proportion of carbonate groups in the polymer depends on the reaction conditions, and by way of example in particular on the catalyst used. In the preferred polypropylene carbonates, more than 85%, and preferably more than 90%, of all of the linkages are carbonate groups. Suitable zinc catalysts and suitable cobalt catalysts are described in U.S. Pat. No. 4,789,727 and U.S. Pat. No. 7,304,172. Polypropylene carbonate can also be produced by the method of Soga et al., Polymer Journal, 1981, 13, 407-10.

It is particularly important that the catalyst is if possible removed quantitatively during work-up. To this end, the reaction mixture is generally diluted to 2- to 10-fold volume with a polar aprotic solvent, for example a carboxylic ester (in particular ethyl acetate), a ketone (in particular acetone), or an ether (in particular tetrahydrofuran). An acid, such as acetic acid, and/or an anhydride, such as acetic anhydride, is then admixed, and the mixture is stirred at slightly elevated temperature for a number of hours. The organic phase is washed and separated. The solvent is preferably removed by distillation in vacuo, and the residue is dried.

The molecular weight Mn of the polypropylene carbonates produced by the abovementioned process is generally from 70 000 and 90 000 daltons. The molecular weight Mw is usually from 250 000 to 400 000 daltons. The ratio of ether groups to carbonate groups in the polymer is from 5 to 90%. In order to improve performance characteristics, it can be advantageous to treat the polypropylene carbonates with maleic anhydride, acetic anhydride, di- or polyisocyanates, di- or polyoxazolines, or -oxazines, or di- or polyepoxides. Polypropylene carbonates with a molecular weight Mn of from 30 000 to 5 000 000 daltons, preferably from 35 000 to 250 000 daltons, and with particular preference from 40 000 to 150 000 daltons, can be produced in this way. Polypropylene carbonates with an Mn below 25 000 daltons usually have low glass transition temperatures below 25° C. These molding compositions moreover have a modulus of elasticity to ISO 527-2 or DIN 53455 of less than 400 MPa and a tensile stress at break of less than 10 MPa. These low-molecular-weight polypropylene carbonates cannot be used for most foil applications. Polydispersity (ratio of weight average (Mw) to number average (Mn)) is generally from 1 to 80, and preferably from 2 to 10. The polypropylene carbonates used can comprise up to 1% of carbamate groups and of urea groups.

Particular chain extenders used for the polypropylene carbonates are maleic anhydride (MA), acetic anhydride, di- or polyisocyanates, di- or polyoxazolines or -oxazines, or di- or polyepoxides. Examples of isocyanates are tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate, and xylylene diisocyanate, and in particular hexamethylene 1,6-diisocyanate, isophorone diisocyanate, and methylenebis(4-isocyanatocyclohexane). Particularly preferred aliphatic diisocyanates are isophorone diisocyanate and in particular hexamethylene 1,6-diisocyanate. Bisoxazolines that may be mentioned are 2,2′-bis(2-oxazoline), bis(2-oxazolinyl)methane, 1,2-bis(2-oxazolinyl)ethane, 1,3-bis(2-oxazolinyl)propane, and 1,4-bis(2-oxazolinyl)butane, in particular 1,4-bis(2-oxazolinyl)benzene, 1,2-bis(2-oxazolinyl)benzene, and 1,3-bis(2-oxazolinyl)benzene. The amounts preferably used of the chain extenders are from 0.01 to 5% by weight, with preference from 0.05 to 2% by weight, and with particular preference from 0.08 to 1% by weight, based on the amounts of polymer. The chain extenders can be added prior to addition of the polymer component ii (i.e. after step (d) in the embodiment of claim 1 or after step (e) in the embodiment of claim 2), or after the addition of polymer component ii (i.e. after step (e) in the embodiment of claim 1 or after step (f) in the embodiment of claim 2).

Polymer component ii that can be used is in particular polymer with a glass transition temperature (Tg) above 40° C. and in particular above 50° C. Polymer component ii) generally means one or more polymers selected from the group consisting of: polyolefins (polyethylene and polypropylene), polystyrene and styrene copolymers, polyamides (nylon-6 and nylon 6,6), polyesters (polyethylene terephthalate and polybutylene terephthalate), polyvinyl chloride, aromatic polycarbonates, polyurethanes, polyamide, polyoxymethylene, and polysulfone.

Biodegradable polymers are particularly preferred as polymer component ii), examples being biodegradable polyesters selected from the group consisting of: polylactide, aliphatic-aromatic polyester, aliphatic polyester, polyhydroxybutyrate, polycaprolactone, cellulose acetate, and cellulose acetate butyrate.

The expression aliphatic-aromatic polyester means polyesters based on aliphatic diols and on aliphatic/aromatic dicarboxylic acids, and also polyester derivatives, such as polyetheresters, polyesteramides, or polyetheresteramides. Among the suitable aliphatic-aromatic polyesters are linear non-chain-extended polyesters (WO 92/09654). Preference is given to chain-extended and/or branched aliphatic-aromatic polyesters. The latter are known from the specifications mentioned in the introduction: WO 96/15173 to 15176, 21689 to 21692, 25446, 25448, or WO 98/12242, expressly incorporated herein by way of reference. Mixtures of different aliphatic-aromatic polyesters can also be used. The expression aliphatic-aromatic polyesters in particular means products such as Ecoflex® (BASF Aktiengesellschaft), Eastar® Bio, and Origo-Bi® (Novamont).

The expression aliphatic polyesters means polyesters made of aliphatic diols and of aliphatic dicarboxylic acids, e.g. polybutylene succinate (PBS), polybutylene succinate adipate (PBSA), polybutylene succinate sebacate (PBSSe), or polybutylene sebacate (PBSe), or corresponding polyesteramides. The aliphatic polyesters are marketed as Bionolle by Showa Highpolymers and as GSPIa by Mitsubishi. EP08165370.1 describes relatively recent developments.

The expression aliphatic polyesters also means cycloaliphatic polyesters, in particular cellulose alkyl esters, such as cellulose acetate, cellulose acetate butyrate, or cellulose butyrate.

It is preferable to use polylactic acid with the following property profile:
a melt volume flow rate (MVR for 190° C. and 2.16 kg to ISO 1133) of 0.5-preferably 2- to 30 ml/10 minutes, in particular 9 ml/10 minutes
melting point below 240° C.;
glass transition temperature (Tg) above 55° C.
water content smaller than 1000 ppm
residual monomer content (lactide) smaller than 0.3%
molecular weight greater than 80 000 daltons.

Examples of preferred polylactic acids are NatureWorks® 4020 or 4042D (polylactic acid from NatureWorks).

Polycaprolactone is by way of example marketed as Placcel® by Daicel.

The expression polyhydroxyalkanoates means primarily poly-4-hydroxybutyrates and poly-3-hydroxybutyrates, and also encompasses copolyesters of the above-mentioned hydroxybutyrates with 3-hydroxyvalerates or 3-hydroxyhexanoate. Poly-3-hydroxybutyrate-co-4-hydroxybutyrates are in particular known from Metabolix. They are marketed as Mirel®. Poly-3-hydroxybutyrate-co-3-hydroxyhexanoates are known from P&G or Kaneka. Poly-3-hydroxybutyrates are marketed by way of example with trademark Biocycle® by PHB Industrial, and as Enmat® by Tianan.

The molecular weight Mw of the polyhydroxyalkanoates is generally from 100 000 to 1 000 000 and preferably from 300 000 to 600 000.

The amounts used of polymer component(s) ii) are generally from 10 to 95% by weight, preferably from 20 to 90% by weight, and particularly preferably from 40 to 80% by weight, based on the polypropylene carbonate.

The polymer mixtures can also comprise additives, such as antiblocking agents, nucleating agents, pigments, flame retardants, lubricants, microbicides, fillers, etc.

The process of the invention includes the following steps:

### Process Variant I

(a) reaction of propylene carbonate with carbon dioxide in the presence of a zinc catalyst, cobalt catalyst, or lanthanoid catalyst—in excess propylene carbonate or in an aprotic non-water-miscible solvent,
(b) addition of an aqueous acidic solution to the reaction mixture after termination of the reaction,
(c) removal of the aqueous phase
(d) optionally washing of the remaining organic phase with water,
(e) addition of polymer component ii),
(f) degassing and drying of the resultant polymer mixture and optionally removal of the aprotic, non-water-miscible solvent, and
(g) pelletization of the polymer melt.

### An Alternative is Process Variant II:

(a) reaction of propylene carbonate with carbon dioxide in the presence of a zinc catalyst, cobalt catalyst, or lanthanoid catalyst—in excess propylene carbonate or in an aprotic non-water-miscible solvent,
(b) addition of an aqueous acidic solution to the reaction mixture after termination of the reaction,
(c) removal of the aqueous phase,
(d) optionally washing of the remaining organic phase with water,
(e) degassing and drying of the resultant polymer mixture and optionally removal of the aprotic, non-water-miscible solvent,
(f) addition of polymer component ii), and
(g) pelletization of polymer melt.

### Re Step (a):

The molar ratio of monomer to catalyst is greater ≧75, preferably ≧85, particularly preferably ≧90. Particular catalysts that can be used are zinc compounds, cobalt compounds, or lanthoid compounds. Metal polycarboxylic acid compounds have proven particularly successful as catalysts. Preference is given here to a metal dicarboxylic acid compound.

Zinc is particularly preferably used as metal. The dicarboxylic acid used preferably comprises glutaric acid (x=3), adipic acid (x=4), or a mixture of the two. It is very particularly preferable to use, as metal dicarboxylic acid compound in the process of the invention, zinc glutarate, zinc adipate, or a zinc dicarboxylate mixture produced from adipic acid and from glutaric acid.

The process of the invention is carried out at a temperature of from 40 to 120° C., preferably from 40 to 100° C., particularly preferably from 40 to 90° C. The reaction pressure for the process of the invention is from 1 to 100 bar, preferably from 10 to 80 bar, particularly preferably from 20 to 60 bar.

In one preferred embodiment, the process pressure during the production of the polycarbonate is generated via the carbon dioxide gas. It is moreover also possible that further gases, for example nitrogen and/or noble gases, are added to the carbon dioxide gas. The reaction can be carried out in stages or continuously. In a preferred method, the catalyst is used as initial charge in the reactor in the appropriate aprotic, non-water-miscible solvent, the propylene oxide is added, and the temperature is brought to the desired reaction temperature, while the pressure is adjusted to the intended value by using carbon dioxide gas or a mixture of carbon dioxide gas and other gases. It is also possible to use a portion of the propylene oxide as initial charge and to add a further portion of the propylene oxide at reaction pressure and/or reaction temperature.

The aprotic, non-water-miscible solvent is an organic solvent, examples being cyclic ethers, alkanes, substituted or unsubstituted aromatic compounds, preferably unsubstituted aromatic compounds or aromatic compounds substituted with from 1 to 4 C₁-C₄-alkyl moieties, particularly preferably benzene, toluene, ethylbenzene, or isomers of xylene. The process can be carried out in a single solvent, but it is also possible to use a mixture of 2 or more of the abovementioned solvents. Halogenated solvents can also be used.

It is preferable that the aprotic, non-water-miscible solvent forms an azeotrope with water, i.e. a mixture which cannot be separated by distillation because the constitution in the liquid and in the gas phase is identical. (The contents in the solution correspond to the partial pressures above the solution.)

### Re Step (b):

After termination of the reaction, the reaction pressure is lowered to atmospheric pressure. An aqueous solution of an inorganic acid selected from the group consisting of hydrochloric acid, sulfuric acid, phosphoric acid, methanesulfonic acid, and mixtures thereof, preferably hydrochloric acid, is then added to the reaction mixture. The acids that can be used are not sterically hindered acids. The concentration of the inorganic acid in water is from 0.001 to 20 M, preferably from 0.001 to 10 M, particularly preferably from 0.05 to 5 M. The aqueous solution of the inorganic acid is added with continuous mixing of the reaction mixture. Good mixing can be achieved via use of, for example, a stirrer, pump equipment, an Ultra-Turrax, a static mixer, and equipment of this type known to a person skilled in the art. It is preferable to use a static mixer. In another embodiment, a MIC stirrer is used to stir the mixture. Prior to addition of the aqueous solution of the inorganic acid, the reaction mixture can be diluted with a suitable organic solvent. Suitable solvents are aliphatic or aromatic, optionally halogenated solvents, for example carbon tetrachloride, chloroform, or methylene chloride. It is possible to use either a single solvent or a mixture of two or more solvents.

Step (b) maximizes removal of residues of the catalyst used and removal of other byproducts.

### Re Step (c):

In this step, the aqueous phase is removed from the organic phase in the two-phase reaction mixture. This can be achieved by methods known to the person skilled in the art. Examples that may be mentioned are decantation or discharge of the phase with the respectively higher density through an aperture in the lower region of the reactor, always after maximum phase separation.

After removal of the aqueous phase, the polycarbonate produced is present in the form of a slurry in the aprotic, non-water-miscible solvent. The solids content of this slurry is from 5 to 75% by weight, preferably from 10 to 50% by weight, particularly preferably from 15 to 40% by weight.

### Re Step (d):

Once removal of the aqueous phase has been maximized, the remaining organic phase is optionally washed with water. To this end, an amount of water which is from 0.5 to 2 times, preferably from 0.7 to 3 times, particularly preferably from 0.9 to 1.5 times, the amount of organic phase is added and mixed completely, and this process is carried out from 1 to 7 times, preferably from 1 to 5 times, particularly preferably from 1 to 3 times. Before each amount of water is added, the amount of water of the previous addition is removed after maximum phase separation. The methods for mixing of, and for removal of, the aqueous phase have been described in step (b) and step (c).

The average molar mass of the polycarbonate produced via the process of steps a) to d) is ≧230 000 g/mol, preferably ≧240 000 g/mol, particularly preferably ≧250 000 g/mol, very particularly preferably ≧300 000 g/mol.

The glass transition temperature of the polycarbonate produced via the process of steps a) to d) is from 10 to 50° C., preferably from 15 to 45° C., particularly preferably from 20 to 40° C.

The polydispersity of the polycarbonate produced via processes of the steps a) to d) is from 2.0 to 12.0, preferably from 2.5 to 10, particularly preferably from 3.0 to 8.0.

### Re Step (e) (Process Variant I=Step (f), Process Variant II):

Polymer component ii) and optionally further additives are introduced in the form of pellets or in the form of melt into a suitable mixing assembly. The mixing assembly can by way of example be a stirred tank or preferably an extruder.

### Re Step (f) (Process Variant I=Step (e), Process Variant II):

The resultant slurry of the polycarbonate in the aprotic, non-water-miscible solvent is degassed and dried by methods known to the person skilled in the art. To this end, the polymer-comprising phase can by way of example be transferred to an extruder by means of a pump. The degassing is carried out at a temperature of from 80 to 300° C., preferably from 120 to 250° C., particularly preferably from 150 to 220° C. The degassing temperature here is preferably above the boiling point of the aprotic, non-water-miscible solvent. The degassing can also be carried out at a pressure below atmospheric pressure, preferably ≦800 mbar, particularly preferably ≦500 mbar, particularly preferably ≦200 mbar. The degassing and drying can by way of example be carried out in an extruder or in a degassing vessel. It is preferable to use an extruder to degas the polycarbonate slurry. To this end, the product mixture is introduced into as twin-screw extruder.

### Re Step (g)

After degassing and drying, the liquid polycarbonate mixture can be cast in an air bath or water bath to give a strand of dimension about 2 to 10 mm, preferably from 4 to 6 mm. This is cropped into particles of length from 0.2 to 50 mm, preferably from 1 to 30 mm. Other pelletization processes are also possible, for example underwater pelletization.

The polycarbonate mixtures accessible by using the process of the invention are suitable by way of example as plastic processing material, in textiles in the form of fiber, or in medical technology, for example in the form of body-replicating impressions or skin substitute.

The polycarbonate mixtures are also suitable for the coating of handles, of sports equipment, such as tennis rackets, badminton rackets, squash rackets, etc., of household equipment, such as mixers, including rod mixers, knives, smoothing irons, whisks, kneaders, pots, spoons, cutting boards, of tools, such as hammers, saws, including compass saws, and in the automobile sector, examples being steering wheel, switches, sidewalls, seats, and in the production of hygiene utensils, such as toothbrushes, WC brushes, hairdryers, and of communications equipment, such as cell phones (keys and grip), landline telephones and of writing equipment, such as ballpoint pens, pencils, and fountain pen holders.

### General Test Methods

### Powder Properties

### Grain Size

Volume-average particle size d₅₀ was measured by a Mastersizer 2000/Hydro 2000 G from Malvern.

### Bulk Density

Bulk density was determined to EN ISO 60.

### Flowability

Flowability was determined by a method based on DIN EN ISO 2431. A flow cup to DIN 53 211 with 6 mm nozzle was used for this purpose.

### Caking

Tendency toward caking was measured by taking 200 g of the powder to be tested and charging it through a 1000 μm sieve into a plastics tube (internal diameter 100 mm, height 160 mm) standing in a Petri dish (diameter 120 mm). A circular plastics sheet (diameter 98 mm) and a weight (brass) of 15 kg were placed on the charge of powder. After a residence time of 2 h at 22° C., the weights were removed and the pressed powder was carefully transferred to a 2000 μm sieve in a sieve shaper machine (Fritsch Analysette 3Pro). The sieve stack was closed and the specimen was sieved at amplitude 0.4 mm. The time needed for all of the powder to fall through the sieve was measured.

### INVENTIVE EXAMPLE 1

Production of a polypropylene carbonate-polylactic acid (80:20) mixture (variant II) Polypropylene carbonate is polymerized in a known manner and, after the polymerization reaction, diluted with ethyl acetate, and the catalyst is decomposed via addition of acetic acid, and water is used for the extraction process (see WO 2007/125039 A1, page 10, examples). The remaining solution comprises about 20% by weight of polypropylene carbonate (molecular weight Mw 225 000).

The PPC solution (20%, 10 kg/h) was degassed in a number of stages in a suitable extrusion machine on a pilot-plant scale, and a melt of a second polymer was introduced, and intimately mixed with, by way of an addition point in the final third of the degassing machine, the melt substantially freed from the solvent.

A corotating ZSK 40 twin-screw compounder of modular structure from Coperion Werner & Pfleiderer is used, with 13 extruder sections and total length 54 D. The machine had been divided into different process zones, each of which was composed of a plurality of identical or different extruder sections.

The first third of the extruder had been constructed as feed zone and first degassing zone, and in section 3 the polymer solution was introduced to the extruder by means of a gear pump by way of a heated line. In this section there were straight conveyor elements and conveying mixing elements which firstly provide a large volume for the vaporization process and secondly ensure good vaporization of the solvent via constant surface renewal. The preheated solution passed into the extruder, which had been heated to temperatures above the boiling point of the solvent and also above the melting range of the polymer. Section 1 of the extruder had been closed, and the screw had been sealed off with respect to the drive by means of suitable elements (reverse-conveying screw flights, non-conveying kneading blocks). Sections 2 and 5 had been equipped to be upward-opening degassing barrel sections, and the solvent vaporizing out of the polymer solution entering in section 3 could therefore be discharged in and counter to the direction of conveying of the extruder. Both apertures were subject to slightly subatmospheric pressure (900 mbar absolute).

Sections 6 and 7 of the extruder were closed sections provided with conveying screw elements. Prior to the transition to section 7, the melt was retarded—for example via a conveying kneading block with retardation via reverse-conveying screw flights—and this part of the extruder was thus sealed off from the next zone. The barrel temperature here was 130° C.

The following sections 8 and 9 had been designed as upward-opening degassing barrel sections, subject to a subatmospheric pressure of about 500 mbar. The barrel temperature was about 150° C. Section 10 was a closed section and again comprised elements for retardation of the melt. Section 11 had a lateral aperture by way of which an ancillary extruder had been attached by means of an adapter and heated melt line. In the present instance this was a 16 mm machine by way of which 400 g/h of polylactide powder (example 1) were melted at 200° C. and conveyed into the main machine (ancillary extruder rotation rate 100 rpm). The main extruder has also been heated to 200° C. from section 11 onward, and at this location between the lateral feed point and the degassing aperture (vacuum 50 mbar abs) located in zone 12 the screw has mixing kneading elements and toothed mixing elements.

The final section 13 is a closed section and has straight conveying elements. The melt was discharged through a die plate (1×3 mm), and the strand was cooled in a water bath and pelletized in a pelletizer. The resultant cylindrical pellets were optionally afterdried to a desired moisture content and placed into inventory for further use.

The other inventive examples 2 to 9 and comparative example 1 were executed by analogy with inventive example 1 using different mixing ratios or using the following polymer components ii):

1. NatureWorks® AD 4042 (polylactide (PLA) from NatureWorks).
2. Ecoflex® FBX 7011 (semiaromatic polyester (PE), from BASF SE).

### 3. Polystyrene (PS) 158 N, BASF SE.

4. Moplen polypropylene (PP), Basel.

The table below lists the polypropylene carbonate mixtures produced by the process of the invention. The PPC/PS, PPC/PP, PPC/PE, and PPC/PLA polymer mixtures are blends in the form of pellets. This also applies to the terblends.

| Polymer mixture-(free) | | | | | | |
|---|---|---|---|---|---|---|
| | Constitution | Flowability after storage [h; d = days] | | | | |
| Ex. | [% by wt.] | 2 h | 20 h | 48 h | 5 d | 10 d |
| comp 1 | 100 PPC | 4* | 6 | 6 | 6 | 6 |
| 1 | PPC/PLA | 1-2 | 2 | 4 | 5 | 5 |
| | 80/20 | | | | | |
| 2 | PPC/PLA | 1-2 | 2 | 2 | 3 | 3 |
| | 60/40 | | | | | |
| 3 | PPC/PLA | 1 | 1 | 1 | 1 | 1 |
| | 30/70 | | | | | |
| 4 | PPC/PS | 1 | 1 | 1 | 1 | 1 |
| | 10/90 | | | | | |
| 5 | PPC/PP | 1 | 1 | 1 | 1 | 1 |
| | 10/90 | | | | | |
| 6 | PPC/PE | 1-2 | 2 | 2 | 2-3 | 2-3 |
| | 40/60 | | | | | |
| 7 | PPC/PE/PLA | 1-2 | 2 | 2 | 2-3 | 2-3 |
| | 40/50/10 | | | | | |
| 8 | PPC/PE/PLA | 1 | 1 | 1 | 1 | 1 |
| | 13/55/32 | | | | | |
| 9 | PPC/PE/PLA | 1 | 1 | 1 | 1 | 1 |
| | 13/42/45 | | | | | |

*1 = no caking, good flowability,
*2 = slight caking, still easily separable,
*3 = slight caking, still free-flowable,
*4 = caking, free-flowable after being shaken once,
*5 = severe caking, free-flowable after repeated shaking,
*6 = caked solid, not free-flowable

1-10. (canceled)

11. A process for the production of polymer mixtures of i) polypropylene carbonate and ii) at least one further polymer, which comprises:
(a) reacting propylene oxide with carbon dioxide in the presence of a zinc catalyst, cobalt catalyst, or lanthanoid catalyst—in excess propylene oxide or in an aprotic non-water-miscible solvent,
(b) adding an aqueous acidic solution to the reaction mixture after termination of the reaction,
(c) removing the aqueous phase,
(d) optionally washing of the remaining organic phase with water,
(e) adding polymer component ii),
(f) degassing and drying of the resultant polymer mixture and optionally removal of the aprotic, non-water-miscible solvent, and
(g) pelletizing the polymer melt.

12. The process according to claim 11, wherein the catalyst in step a) is a zinc compound.

13. The process according to claim 12, wherein the catalyst is zinc glutarate, zinc adipate, or a zinc dicarboxylate mixture produced from adipic acid and from glutaric acid.

14. The process according to claim 11, wherein the aprotic, non-water-miscible solvent in step a) forms an azeotrope with water.

15. The process according to claim 11, wherein the aqueous acid in step b) is acetic acid, hydrochloric acid, sulfuric acid, phosphoric acid, methanesulfonic acid, or mixtures thereof.

16. The process according to claim 13, wherein the aqueous acid in step b) is acetic acid, hydrochloric acid, sulfuric acid, phosphoric acid, methanesulfonic acid, or mixtures thereof and the aprotic, non-water-miscible solvent in step a) forms an azeotrope with water.

17. The process according to claim 11, wherein polymer component ii) used comprises one or more polymers selected from the group consisting of: polyolefin, polystyrene, styrene copolymers, polyvinyl chloride, polyester, polyurethane, polyamide, polyoxymethylene, and polysulfone.

18. The process according to claim 16, wherein polymer component ii) used comprises one or more polymers selected from the group consisting of: polyolefin, polystyrene, styrene copolymers, polyvinyl chloride, polyester, polyurethane, polyamide, polyoxymethylene, and polysulfone.

19. The process according to claim 17, wherein polymer component ii) used comprises one or more biodegradable polyesters selected from the group consisting of: polylactide, aliphatic-aromatic polyester, aliphatic polyester, polyhydroxybutyrate, polycaprolactone, cellulose acetate, and cellulose acetate butyrate.

20. The process according to claim 18, wherein polymer component ii) used comprises one or more biodegradable polyesters selected from the group consisting of: polylactide, aliphatic-aromatic polyester, aliphatic polyester, polyhydroxybutyrate, polycaprolactone, cellulose acetate, and cellulose acetate butyrate.

21. The process according to claim 11, wherein the amount used of polymer component ii) is from 10 to 80% by weight, based on the polypropylene carbonate.

22. The process according to claim 11, wherein the amount used of polymer component ii) is from 15 to 50% by weight, based on the polypropylene carbonate.

23. The process according to claim 20, wherein the amount used of polymer component ii) is from 15 to 50% by weight, based on the polypropylene carbonate
